(19) United States
(12) Patent Application Publication
(10) Pub. No.: US 2001/0003761 A1
(43) Pub. Date: Jun. 14, 2001

(54) FORMED ARTICLE OF BIODEGRADABLE RESIN

(76) Inventors: AKIRA ISHIBASHI, TOYAMA-KEN (JP); MAMORU TANAKA, TOYAMA-KEN (JP); MUTSUO HIROTA, TOYAMA-KEN (JP); YOSHIFUMI MIYAJIMA, TOYAMA-KEN (JP)

Correspondence Address: Finnegan, Henderson, Farabow, Garrett & Dunner LLP, 1300 I Street, N.W., Washington, DC, 20005-3315, US

(21) Appl. No.: 09/210,539

(22) Filed: Dec. 14, 1998

(30) Foreign Application Priority Data
Dec. 15, 1997 (JP) 9-362506
Dec. 25, 1997 (JP) 9-366176

(51) Int. Cl. C08K 3/26

(52) U.S. Cl. 524/425; 524/451; 524/539; 525/444; 525/450

(57) ABSTRACT

Disclosed is a formed article made of a biodegradable resin material which maintains strength sufficient for practical use and, when discarded after use, succumbs to decomposition by the action of microorganisms occurring in the physical world without bringing destruction on the physical environment or inducing public nuisance in consequence of the decomposition. The formed article is formed of a multicomponent polymer material comprising a continuous phase and a disperse phase; the continuous phase is made of a polybutylene succinate type and/or polyethylene adipate type aliphatic polyester and the disperse phase is made of polylactic acid. The continuous phase may comprise the aliphatic polyester containing such an inorganic filler as talc or calcium carbonate. The formed article of biodegradable resin constructed as described above may be manufactured in arbitrarily selected shapes and used for products in various fields, particularly for slide fasteners and separable fasteners.

### BACKGROUND OF THE INVENTION

1. Field of the Invention

This invention relates to a formed article made of a biodegradable resin material comprising an aliphatic polyester, such as polybutylene succinate or polyethylene adipate, and polylactic acid. The invention relates particularly to formed articles for fasteners which are fabricated by injection molding or extrusion molding.

2. Description of the Prior Art

The products of synthetic resin in use to date, owing to the outstanding features thereof such as light weight, low price, and easy workability, have infiltrated into every area of our daily life and now constitute themselves indispensable raw materials in the modern economic society. Fasteners are no exception to this statement. The resinous fasteners using synthetic resins are utilized in various products which allow the characteristic features of synthetic resin to be harnessed advantageously. These products of synthetic resin, however, entail such problems of public nuisance as, for example, destruction and pollution of natural environment when they are discarded after use because they are suffered to persist in their undecomposed state and accumulate in the natural environment.

In the circumstances, the idea of incorporating the resinous products into the mass circulation of the natural world, namely the plan for ultimately decomposing resinous products into water and carbon dioxide by the use of microorganisms which are present in the physical world, has come to be contemplated. As a result, the development of various biodegradable resins which are novel materials possessed of “biodegradability” is now under way.

The biodegradable resins which are cited in the present specification, polybutylene succinate and polyethylene adipate are kinds of aliphatic polyester which are chemically synthesized mainly from glycol and aliphatic dicarboxylic acid. In terms of chemical structural formula, they are mainly expressed by the following general formulas (1) and (2).

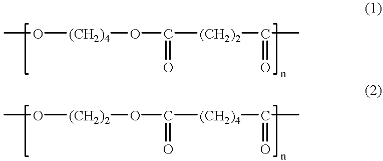

As regards the polybutylene succinate, a biodegradable resin using this compound as a main component has been already marketed under the trademark designation of “Bionolle”. The “TECHNICAL DATA SHEET, Bionolle, Biodegradable Plastic (1996)” issued by Showa Highpolymer Co., Ltd., the producer of this biodegradable resin, offers such information as the outline, attributes, and structure thereof.

The polylactic acid is chemically synthesized by using L-lactic acid as a monomer. The main chemical structural formula of the polylactic acid is represented by the following general formula (3).

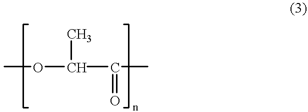

As regards the polylactic acid, the biodegradable resin “LACT” using polylactic acid as a main component has been already marketed. The “SHIMADZU LACT Report—Lactic Acid Type Biodegradable Plastic No. 1 LACT” issued by Shimadzu Seisakusho K. K., the producer of this biodegradable resin, offers such information as the structure, attributes, and mechanical properties thereof.

While these biodegradable resins are as stable in the air as wood and paper, they succumb to biodegradation in compost, wet soil, activated sludge, fresh water, and seawater and ultimately yield to decomposition into water and carbon dioxide.

Though the cases of successful adaptation of these biodegradable resins for practical use are still few in number, the products which use such biodegradable resins as have only a light load on the physical environment have begun to appear as alternatives for the existing products of synthetic resin.

### SUMMARY OF THE INVENTION

The use of such biodegradable resins as mentioned above in such actual products as fasteners, however, incurs a heap of problems on strength and moldability which remain yet to be solved. Unfortunately, none of the biodegradable resins which have been already introduced to the market satisfies all these requirements.

An object of the present invention, therefore, consists in developing a method for the production of a formed article of biodegradable resin which imparts to the biodegradable resin such strength as suffices effective use of the resin in such products as, for example, fasteners and also allows the resin to exhibit improved moldability during the course of production and thereby providing a formed article of biodegradable resin which has practically sufficient mechanical properties and allows itself to be discarded after use without inducing such problems of public nuisance as destruction and pollution of the physical environment.

To accomplish the object mentioned above, the present invention provides a formed article made of a biodegradable resin material comprising as main components thereof a continuous phase of at least one aliphatic polyester selected from the group consisting of polybutylene succinate and polyethylene adipate and a disperse phase of polylactic acid. In the formed article of biodegradable resin, the aliphatic polyester component accounts for a proportion of not less than 50% by weight of the material and the polylactic acid is dispersed in the form of particles in the aliphatic polyester.

In a preferred embodiment of the formed article of biodegradable resin, the continuous phase of aliphatic polyester contains an inorganic filler. Preferably the inorganic filler contained in the continuous phase is talc or calcium carbonate. In this case, the polylactic acid component is preferred to account for a proportion in the range of 5 to 45% by weight of the material.

The formed articles of biodegradable resin constructed as described above can be obtained in arbitrarily selected shapes and used for products in various fields. Since they retain very high strength, they can be utilized particularly advantageously for slide fasteners and separable fasteners.

### BRIEF DESCRIPTION OF THE DRAWINGS

Other objects, features, and advantages of the invention will become apparent from the following description taken together with the drawings, in which:

FIG. 1 is a graph showing the elongation exhibited in a tensile test by a resin having a varying polybutylene succinate/polylactic acid mixing ratio;

FIG. 2 is a polarized photomicrograph showing the sectional texture of a monofilament made of a resin having a polybutylene succinate/polylactic acid mixing ratio of 50/50 (in weight ratio);

FIG. 3 is a graph showing the relation between the tensile strength and the polylactic acid particle diameter of a resin formed of polybutylene succinate and polylactic acid;

FIG. 4 is a graph showing the elongation exhibited in a tensile test by a resin material having a varying inorganic filler-containing polybutylene succinate/polylactic acid mixing ratio;

FIG. 5 is a polarized photomicrograph showing the sectional texture of a monofilament made of a resin having a talc-containing polybutylene succinate/polylactic acid mixing ratio of 75/25 (in weight ratio);

FIG. 6 is a plan view illustrating one embodiment of a slide fastener made of a biodegradable resin;

FIG. 7 is a plan view illustrating another embodiment of a slide fastener made of a biodegradable resin;

FIG. 8 is a plan view illustrating still another embodiment of a slide fastener made of a biodegradable resin;

FIG. 9 is a partially cutaway plan view illustrating another embodiment of a slide fastener made of a biodegradable resin;

FIG. 10 is a partial perspective view of the first embodiment of a male fastener member of a separable fastener made of a biodegradable resin;

FIG. 11 is a fragmentary cross section illustrating the state of engagement between the male fastener member shown in FIG. 10 and a female fastener member, both made of a biodegradable resin, with the male fastener member showing a cross section thereof taken through FIG. 10 along the line XI-XI;

FIG. 12 is a partial perspective view of the second embodiment of a male fastener member made of a biodegradable resin;

FIG. 13 is a fragmentary cross section illustrating the state of engagement between the male fastener member shown in FIG. 12 and a female fastener member, both made of a biodegradable resin, with the male fastener member showing a cross section thereof taken through FIG. 12 along the line XIII-XIII;

FIG. 14 is a perspective view of the third embodiment of a separable fastener made of a biodegradable resin;

FIG. 15 is a partially cutaway side view illustrating a method for engagement of the biodegradable separable fastener shown in FIG. 14;

FIG. 16 is a fragmentary cross section of the fourth embodiment of a female fastener member made of a biodegradable resin;

FIG. 17 is a fragmentary cross section of the fourth embodiment of a male fastener member made of a biodegradable resin;

FIG. 18 is a fragmentary cross section illustrating the state of lamination of a water-soluble resin on the reverse side of a male fastener member made of a biodegradable resin as the fifth embodiment of the present invention;

FIG. 19 is a fragmentary cross section illustrating the fifth embodiment of the male fastener member made of a biodegradable resin;

FIG. 20 is a fragmentary cross section of the sixth embodiment of a male fastener member made of a biodegradable resin; and

FIG. 21 is a schematic diagram illustrating the method for determining the lateral tensile strength in Examples 1 and 2.

### DETAILED DESCRIPTION OF THE INVENTION

The present invention, with a view to imparting to a biodegradable resin such strength as fully suffices effective use of the resin as in fasteners, for example, and at the same time enabling the resin to exhibit improved moldability important for the process of production, consists in compounding two different kinds of biodegradable resin materials thereby compensating these biodegradable resins severally for their defects and deriving good qualities from the physical properties of the individual resin materials. In the category of the conventional synthetic resins, this approach generally passes under the name of polymer blend technique. The substance of this technique is described in detail in Saburo Akiyama et al. “Polymer Blend” published by CMG Press (1981), for example.

The present inventors, after pursuing a diligent study on the strength of biodegradable resin which constitutes itself a matter of grave concern in the utilization of the biodegradable resin such as in fasteners, have taken notice of the state of dispersion of biodegradable resin and consequently discovered that the control of this state of dispersion brings about a significant effect on the material strength and further that the particle diameter of the component forming the disperse phase of the biodegradable resin and the material strength copiously correlate each other and the material strength is markedly increased by limiting the particle diameter to below a specific magnitude.

Generally, in the polymer materials, when two components are mixed, one of them forms a disperse phase and the other forms a continuous phase. These phases are collectively referred to as a sea and island structure and bear heavily on the strength of material. This phenomenon has been minutely investigated with respect to the multicomponent systems in the existing synthetic resins and the outcomes of the investigation are described in detail in the book compiled by Kobunshi Gakkai, titled “Polymer Alloy—Base and Applications,” and published by Tokyo Kagaku Dojin (1981).

In fact, in the formed article of a biodegradable resin composed of a polybutylene succinate type and/or polyethylene adipate type aliphatic polyester (hereinafter simply called an aliphatic polyester when collectively referred to) and a polylactic acid, one of the components is destined to form a disperse phase and the other a continuous phase. The formed article has the physical properties thereof widely varied, depending on which of the two component resins forms the disperse phase. This choice is decided by the mixing ratio of the two biodegradable resins.

When resins having polybutylene succinate and polylactic acid in varying mixing ratios were prepared and examined for physical properties, it was clearly found that the magnitude of elongation during the tensile test depended largely on the state of dispersion of the two resins.

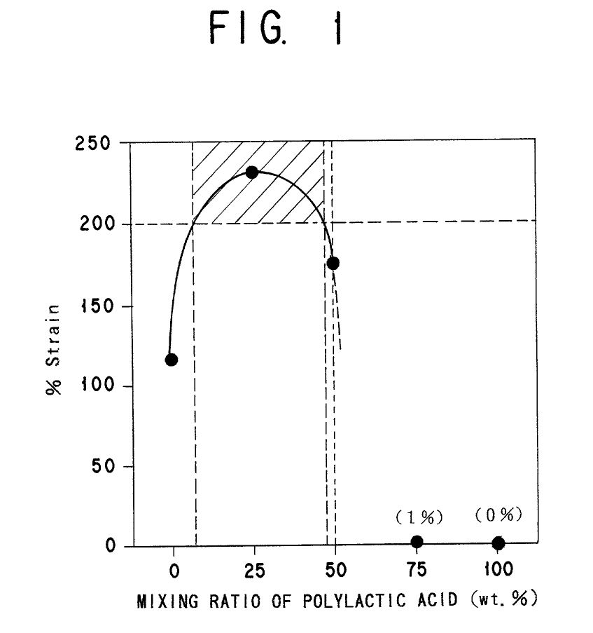

FIG. 1 depicts the elongation during the tensile test relative to the mixing ratio of the two resins in a relevant sample. In the diagram of FIG. 1, the horizontal axis is the scale of the proportion of the polylactic acid to the total amount of the mixed resins expressed in % by weight and the vertical axis is the scale of the elongation expressed in % strain. The hatched part enclosed with a dotted line in the diagram (the proportion of polylactic acid ranging from 10 through 45% by weight and the % strain above 200%) represents a recommended range. The distance between two gage marks on a test piece used in the measurement of elongation was 50 mm.

It is noted from the results shown in FIG. 1 that the elongation markedly increases when the proportion of the polybutylene succinate component exceeds 50% by weight and that the magnitude of % strain surpasses 200% and the elongation reaches the maximum when the proportion of the polybutylene succinate component is in the approximate range of 55 to 90% by weight. The elongation grows in accordance as the proportion of the polybutylene succinate component increases. From this fact, it is easily inferred that the polybutylene succinate which accounts for such a large proportion easily forms the continuous phase. In fact, when the mixed resins having the mixing ratios in the range mentioned above are observed to test for the state of dispersion under an optical microscope, it is understood that the polylactic acid forms the disperse phase and the polybutylene succinate the continuous phase (FIG. 2). FIG. 2 is a polarized photomicrograph of the cross section of a monofilament having a polybutylene succinate/polylactic acid mixing ratio of 50/50 (in weight ratio). The cross section was photographed by using a quarter-wave plate under the condition of cross Nichol. The matrix part of the diagram represents the polybutylene succinate component and the speckled part the polylactic acid component.

The results shown above indicate that by using the polylactic acid for the disperse phase and the polybutylene succinate for the continuous phase, namely by forming a two-phase structure having the particles of the polylactic acid dispersed in the matrix of the polybutylene succinate, and further by using the polybutylene succinate component in a proportion exceeding 50% by weight, preferably falling in the range of 55 to 90% by weight, the binary resin product consequently produced is enabled to acquire a marked improvement in elongation.

The present invention, for the purpose of improving the elongation which constitutes itself an important position in the mechanical properties of material and in view of the results discussed above, is directed to providing a formed article of biodegradable resin comprising a part which is composed of the two components of aliphatic polyester and polylactic acid wherein the aliphatic polyester component accounts for a proportion of not less than 50% by weight and the particles of the polylactic acid are dispersed in the matrix of the aliphatic polyester to give rise to a two-phase structure.

For the purpose of producing the formed article of biodegradable resin constructed as described above, it suffices during the mixture of the aliphatic polyester with the polylactic acid to use the aliphatic polyester in a larger proportion than the polylactic acid. Specifically, for the sake of enabling the aliphatic polyester to form the continuous phase in the binary aliphatic polyester/polylactic acid resin, the proportion of the aliphatic polyester during the mixture of the two biodegradable resins is required to be not less than 50% by weight based on the total weight of the resins. Since the resinous material answering this description exhibits such a high elongation as mentioned above, it allows production of the formed article with high moldability.

The present inventors, after continuing their study further, have discovered that in the formed article characterized by fulfilling the condition mentioned above, namely the two-phase structure having the particles of the polylactic acid dispersed in the matrix of the aliphatic polyester, the strength of the material is heavily affected by the diameter of the particles of the polylactic acid in the structure.

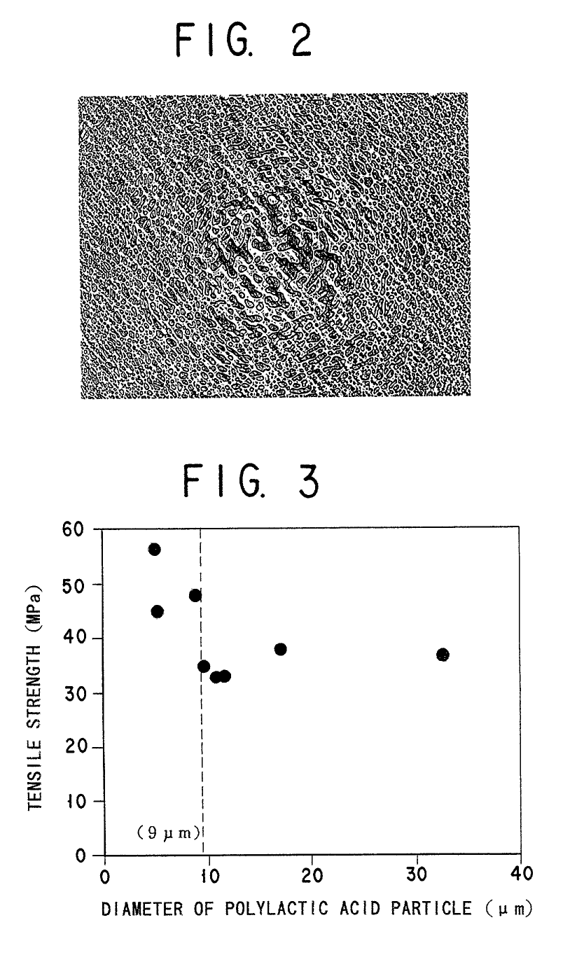

Generally, in the multicomponent polymer material, the magnitude of the diameter of the particles forming the disperse phase brings about a large effect on the strength of the material. The strength of the material increases in accordance as the diameter of the particles of the disperse phase decreases. In fact, in the binary resin mentioned above in which the polybutylene succinate forms the continuous phase and the polylactic acid the disperse phase, the relation between the diameter of the polylactic acid particles of the disperse phase and the material strength can be obtained by an experiment. This relation is determined in the relevant binary biodegradable resin by preparing a number of samples containing polylactic acid particles of varied diameters, measuring the diameters of polylactic acid particles in each sample, finding the strength of the sample by a tensile test, and correlating the resultant data of particle diameter and strength. The results of this experiment are shown in FIG. 3. The mixing ratio of polybutylene succinate/polylactic acid in the samples prepared in this experiment was 75/25 (in weight ratio).

It is clearly noted from FIG. 3 that conspicuous increases in the material strength were observed when the diameters of polylactic acid particles were not more than 9 μm. Specifically, in the preferred embodiment of the present invention, the formed article of biodegradable resin produced in the two-phase structure having the particles of the polylactic acid dispersed in the matrix of the aliphatic polyester is enabled to acquire a markedly improved strength by causing the particles of the polylactic acid to have diameters of not more than 9 μm. For the sake of improving the resinous material in strength, the polylactic acid component is preferred to have as small a particle diameter as permissible. It is inferred that the polylactic acid particles assume the smallest diameters and the resinous material acquires the highest strength when the polybutylene succinate and the polylactic acid are in a mutually miscible state. While the impartation of this mutual miscibility to the two resins is theoretically possible, it is not feasible from the viewpoint of cost because it calls for special equipment and technique in the actual work of blending. The present inventors have tried this blending with the conventional kneading device under the standard conditions to find that the smallest diameter of the polylactic acid particles is 2 μm. It is, therefore, inferred that the particles of the polylactic acid which forms the disperse phase preferably have diameters in a practical range of not less than 2 μm.

The biodegradable resins, i.e. the polybutylene succinate and/or polyethylene adipate type aliphatic polyester and the polylactic acid, to be used in the present invention, can be produced by known methods and they can be adopted for the use without any particular restriction.

The present inventors, after further continuing a diligent study on the strength of biodegradable resin which constitutes itself the problematic point confronting the utilization of the resin as in fasteners, have discovered an unexpected fact that the ternary system to be obtained by causing the continuous phase of biodegradable resin containing an inorganic filler to incorporate therein a small amount of another biodegradable resin destined to form a disperse phase can acquire a marked addition to the “elongation” which brings about a great effect on the mechanical strength of material. Specifically, the second aspect of the present invention resides in providing a formed article of biodegradable resin excellent in strength by preparing a biodegradable resin material abounding in expansibility by such means as mentioned above and using this resin as the raw material.

Now, the operation mentioned above will be explained below with reference to a case of using a talc (or calcium carbonate)-containing polybutylene succinate for the continuous phase of an inorganic filler-containing biodegradable resin on the one hand and polylactic acid, a biodegradable resin, for the disperse phase on the other hand.

When the talc-containing polybutylene succinate and the polylactic acid are used independently of each other, they both exhibit only small elongations as evinced by the fact that the elongation of polybutylene succinate containing 30% by weight of talc is 6.4% and that of polylactic acid is 1.0%.

Incidentally, by using a talc-containing polybutylene succinate for the continuous phase and meanwhile using a polylactic acid for the disperse phase and then kneading these two components, a formed article of biodegradable resin which exhibits an elongation approximating closely to 300% can be provided. Now, this fact will be explained below based on the results of an actual test.

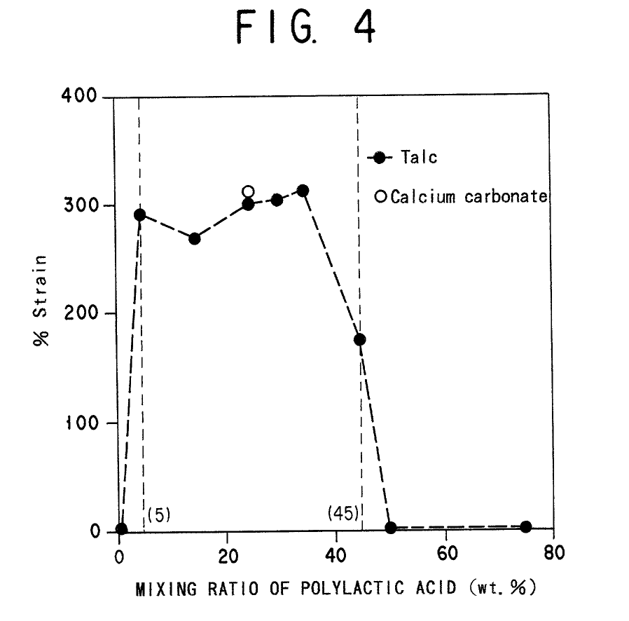

FIG. 4 shows the data of elongation at rupture obtained in a tensile test performed on samples of resin material using polybutylene succinate containing 30% by weight of an inorganic filler (talc or calcium carbonate) and polylactic acid at varying mixing ratios. In the diagram of FIG. 4, the lateral axis is the scale of the proportion in % by weight of the polylactic acid to the total weight of the mixed resin material containing the inorganic filler and the vertical axis is the scale of the elongation in % strain. The part enclosed with a dotted line in the diagram (the proportion of polylactic acid ranging from 10 through 45% by weight) represents a recommended range. The distance between two gage marks on a test piece used in the measurement of elongation was 50 mm.

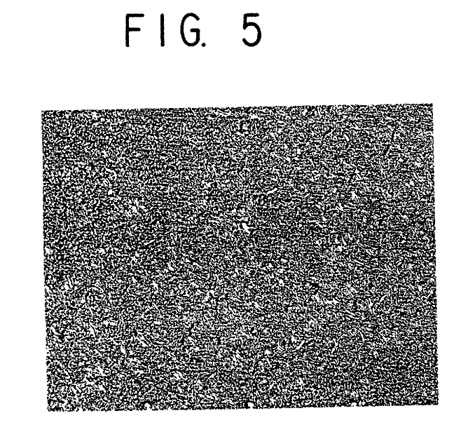

It is noted clearly from the results shown in FIG. 4 that the elongation during the tensile test depends largely on the mixing ratio of the two resins, namely the talc-containing polybutylene succinate and the polylactic acid. Generally, in the multicomponent polymer material, it is known that when the components of the material are mixed, the component of the largest amount forms a continuous phase and the component of the smallest amount forms a disperse phase. The test results mentioned above also seem to indicate that at the mixing ratio (the proportion of polylactic acid in the range of 5 to 45% by weight) at which the greater elongation is observed, the talc-containing polybutylene succinate forms the continuous phase and the polylactic acid forms the disperse phase. It can be understood that when the samples of resin material having the mixing ratios in the range mentioned above are actually observed under an optical microscope to test for state of dispersion, the talc-containing polybutylene succinate is found to form the continuous phase and the polylactic acid the disperse phase (FIG. 5). FIG. 5 represents a polarized photomicrograph of the cross section of a monofilament which has a talc-containing polybutylene succinate/polylactic acid mixing ratio of 75/25 (in weight ratio). The cross section was photographed by using a quarter-wave plate under the condition of cross Nichol. In the diagram, the matrix part represents the polybutylene succinate component, the white chip-like parts represent the polylactic acid component, and the black chip-like parts represent the talc.

The results described above indicate that by using the talc-containing polybutylene succinate for the continuous phase and the polylactic acid for the disperse phase, namely by forming a three-phase structure having the particles of the polylactic acid dispersed in the talc-containing polybutylene succinate, the resultant biodegradable resin material can be endowed with marked elongation. It is further clear from the results shown in FIG. 4 mentioned above that for the sake of imparting high elongation to the resin material, the biodegradable resin forming the disperse phase is preferred to account for a proportion in the range of 5 to 45% by weight based on the total weight of the resin material.

The same effect can be obtained even when calcium carbonate is selected as the inorganic filler for the continuous phase. One example of test results using calcium carbonate is shown additionally in FIG. 4.

The formed article can be improved in elongation and strength by using therefor the three-phase structure having the two different kinds of biodegradable resin and the inorganic filler mixed in such construction and ratio as mentioned above. Since this complex resin material exhibits such high elongation as mentioned above, it allows production of a formed article with high moldability.

The present invention, as described in detail above, represents a case of producing a biodegradable resin with the three-phase structure using polybutylene succinate for the continuous phase, polylactic acid for the disperse phase, and talc and calcium carbonate as the inorganic filler. Though the combination of these components constitutes itself a preferred embodiment of the present invention, the present invention does not need to be limited to this particular combination.

Though talc and calcium carbonate mentioned above are suitably usable for the inorganic filler, the inorganic filler does not need to be limited thereto. As concrete examples of the inorganic filler usable effectively herein, various known and popularly used fillers including clay, kaolin, carbon, mica, silica, aluminum oxide, aluminum hydroxide, magnesium carbonate, magnesium oxide, magnesium hydroxide, and barium sulfate may be cited. Particularly when an inorganic compound occurring in the physical world is selected as the inorganic filler and contained in the formed article of biodegradable resin, the effect which the inorganic filler in the formed article exerts on the physical world when the formed article is discarded after use is thought to be extremely small. The inorganic filler incorporated in the ordinary quantitative proportion suffices the intended purpose. Generally, this amount is not less than 5 parts by weight and not more than 100 parts by weight, preferably 10 to 50 parts by weight, based on 100 parts by weight of the biodegradable resin forming the continuous phase.

The formed article contemplated by the present invention is not discriminated on account of the particular method of production to be adopted. The most typical method of production comprises first kneading an aliphatic polyester and polylactic acid in a weight ratio having the aliphatic polyester in a major proportion at about 190° C. with a kneading device and then molding the resin resulting from the kneading by means of an injection molding device thereby obtaining easily with high reproducibility an injection molded article of biodegradable resin abounding in strength and characterized by comprising a two-phase structure having particles of the polylactic acid component dispersed in the matrix of the aliphatic polyester. The second embodiment of the invention comprises preparatorily incorporating an inorganic filler endowed with compatibility by a surface treatment into a biodegradable resin destined to form a continuous phase, namely, polybutylene succinate type and/or polyethylene adipate type aliphatic polyester, thoroughly kneading the two components together, then mixing the product of kneading with a polyacetic acid at a stated proportion, preferably in the approximate range of 5 to 45% by weight, based on the weight of the total mixture, kneading the components consequently joined at about 190° C. by the use of a kneading device, and then molding the resultant resin with an injection molding device thereby obtaining easily with high reproducibility an injection molded article of biodegradable resin abounding in strength and characterized by comprising a three-phase structure having particles of the polyacetic acid as a disperse phase dispersed in the matrix of the aliphatic polyester containing talc, for example.

The kneading temperature does not need to be fixed at the magnitude mentioned above. The kneading which is performed at a temperature exceeding the melting points of the relevant resins suffices for the intended purpose. Optionally, the kneading of the two resins may be effected by a method which avoids using a kneading device, namely a method which comprises mixing the two resins each in the shape of pellets prior to the step of molding.

The formed article of biodegradable resin according to the present invention can be applied to various fields. Since it has amply high strength for practical use, it can be advantageously used in slide fasteners and separable fasteners. Particularly, in the slide fasteners, the complex material of biodegradable resin according to the present invention can be advantageously used for injection molding the coupling elements thereof.

Now, the modes of embodying the present invention in various slide fasteners will be specifically described below with reference to the accompanying drawings.

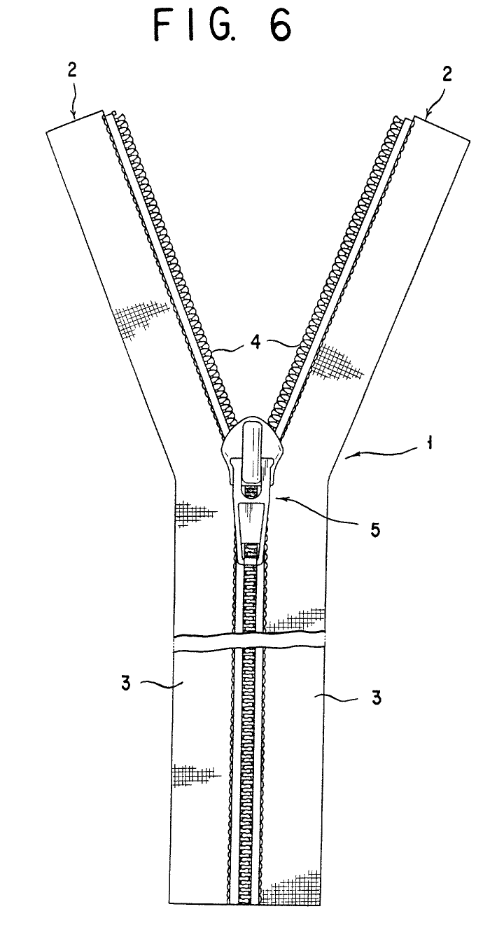

FIG. 6 illustrates a slide fastener 1 which is used for opening and closing the opening in a garment or a bag and depicts the form of a product having the upper and lower ends of laterally paired fastener stringers 2 cut off. The fastener stringers 2 are composed of fastener tapes 3 made of biodegradable resin and a row of coupling elements (coiled coupling elements) 4 made of biodegradable resin attached fast to each of the opposed longitudinal edges of the fastener tapes 3. The fastener tapes 3 are formed by weaving and/or knitting biodegradable resin fibers, manufactured from a non-woven fabric, or made of a sheet of biodegradable resin. The coupling elements 4 are known in various forms such as, for example, those of the type obtained by injection molding the individual coupling elements and simultaneously attaching them fast to the edges of the fastener tapes, the continuous coupling elements such as the coiled coupling elements obtained by winding a monofilament of biodegradable resin in the shape of a coil and the so-called zigzag coupling elements obtained by alternately connecting vertically in a zigzagging pattern in the longitudinal direction the portions bent in the shape of a letter U in the lateral direction in a plane, and the extrusion molded coupling elements obtained by attaching the opposite end portions of the individual coupling elements by means of extrusion molding to the two separate connecting cords (core cords) laid parallel to each other in the longitudinal direction thereby forming a composite resembling a ladder and bending the composite in the shape of a letter U around the longitudinal center line thereof. When the coiled coupling elements, for example, are used in a slide fastener, it further includes a core cord and a sewing thread as the component parts thereof. The reference numeral 5 denotes a slider which is slidable along the opposed rows of coupling elements for making and breaking engagement of the coupling elements.

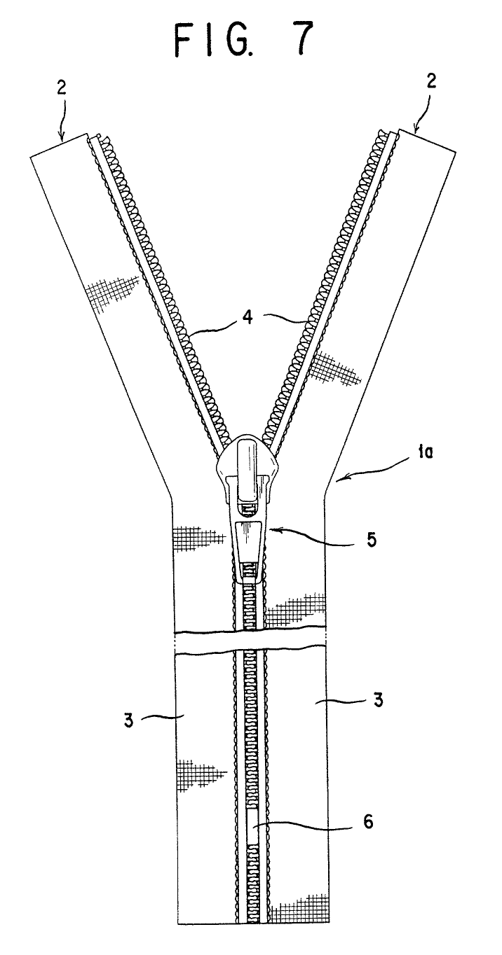

A slide fastener 1a illustrated in FIG. 7 is in a form having the upper ends of the two fastener stringers 2 cut off. It is different from the slide fastener illustrated in FIG. 6 in respect that a lower stopping part 6 is formed by fusing the prescribed lower portions of the engaged rows of coupling elements 4.

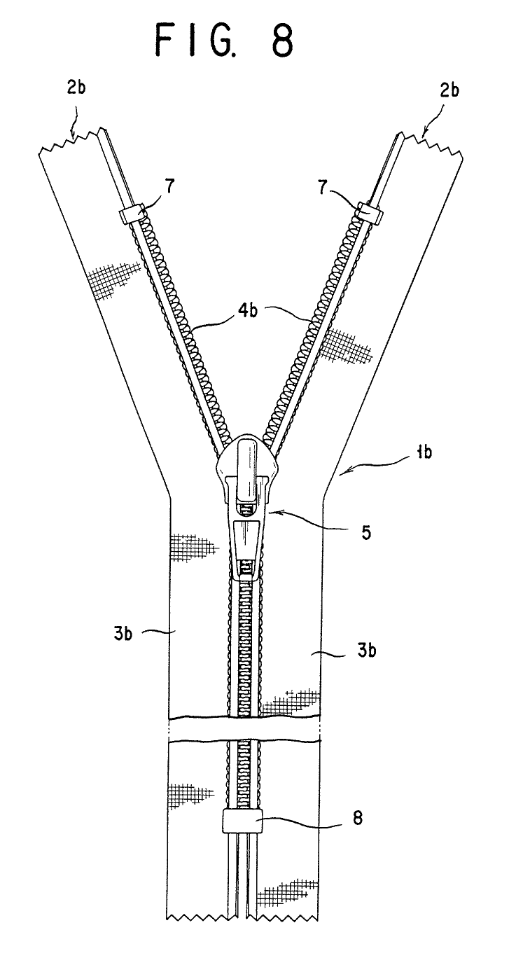

A slide fastener 1b illustrated in FIG. 8 is different from the slide fastener illustrated in FIG. 6 in respect that upper stop members 7 are attached respectively to the upper ends of the rows of coupling elements 4b attached fast to fastener tapes 3b of fastener stringers 2b and a lower stop member 8 is attached to the lower ends thereof.

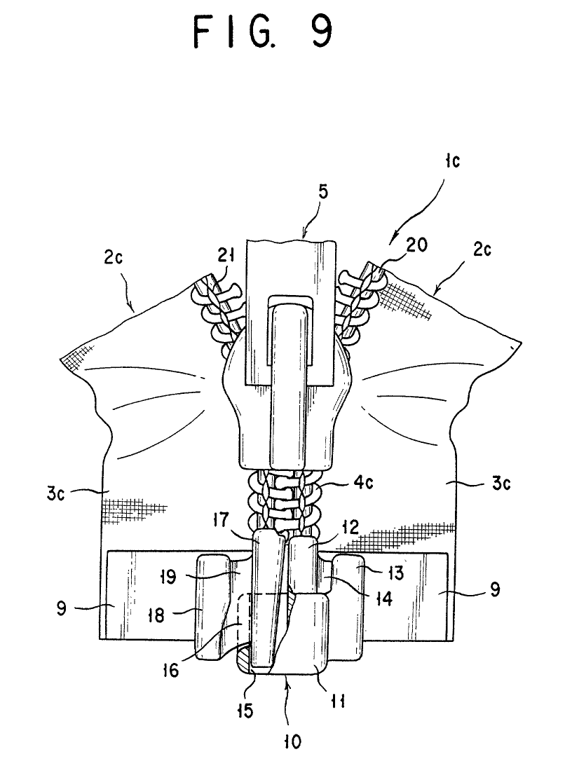

FIG. 9 illustrates an open-link type slide fastener 1c. To the lower end portions of fastener tapes 3c of fastener stringers 2c, reinforcing sheet-like members (taffeta) 9 are welded through the medium of an adhesive layer (not shown). A box member 11 of a pin-and-box separator 10 is attached to the inner edge of one of the opposed reinforcing sheet-like members 9 and a butterfly rod or pin 17 is attached to the inner edge of the other reinforcing sheet-like member 9. The box member 11 is formed integrally with a guide projecting part 13 adjoining the box member 11 and a box rod 12 and a groove 14 is formed as interposed between the box rod 12 and the guide projecting part 13 so as to admit therein the lower end part of the slider 5 by slippage. Similarly, a guide groove 19 is formed between the butterfly rod 17 and a guide ridge 18 formed integrally with the adjoining butterfly rod 17. A butterfly rod inserting hole 15 is formed as pierced in the vertical direction in the left side portion of the box member 11 and a lateral groove 16 is formed on the outer wall of the butterfly rod inserting hole 15. When the butterfly rod 17 is inserted into the butterfly rod inserting hole 15 of the box member 11, therefore, the insertion can be smoothly carried out because the inner side of the lower end of the guide ridge 18 slide on the edge of the lateral groove 16 of the box member 11 so as to guide the butterfly rod 17.

With reference to FIG. 9, the reference numeral 20 denotes a core cord which is inserted in the longitudinal direction through the empty space inside the spiral of the coiled coupling element 4c and the reference numeral 21 denotes a sewing thread sewing the core cord 20 and the coiled coupling element 4c along the longitudinal edge of the fastener tape 3c.

The pin-and-box separator does not need to be limited to what is illustrated in FIG. 9. The so-called reverse open-link type using the same box member as in the construction of the slider 5 and enabling the slider fastener to effect engagement and disengagement of the opposed rows of coupling elements at the lower end thereof, for example, has been known as one version thereof.

Further, the embodiment, as illustrated in the diagram, uses reinforcing sheet-like members which are formed separately of the pin-and-box separator and welded to the lower end portion of each of the fastener tapes. The reinforcing sheet-like members do not need to be limited to this particular construction. The reinforcing members can be integrally formed with the pin-and-box separator as found, for example, in a construction which has a sheet-like portion produced by injection molding a biodegradable resin material integrally with a box member or a butterfly rod and fixed to the entire width of the fastener tape or a construction which has slits of an arbitrarily selected pattern inserted in a sheet-like portion thereby imparting flexibility thereto.

The present invention permits manufacture of all the component parts of a slide fastener such as fastener tapes, coupling elements, a slider, upper and lower stop members, a sewing thread, a core cord, a pin-and-box separator, and reinforcing sheet-like members from the biodegradable resin of the present invention. Part of the component parts may be manufactured from other biodegradable resin or synthetic resin.

In manufacturing a slide fastener made of resin, the question as to what kind of resin material is suitable for the manufacture is judged depending on the form of the slide fastener as a product and the constructions of the individual component parts. Some cases require that the slider itself, for example, should be manufactured from other resin or metal, depending on the function or the construction to be required. In such cases, the slider can be manufactured from the material which is so needed.

The biodegradable resin of the present invention can be applied to other types of fasteners such as, for example, the rail type fastener besides the slide fasteners mentioned above.

On the other hand, a separable fastener made of a biodegradable resin is required from the viewpoint of function to possess durability enough to warrant ample engaging force in spite of the repeated use. Since the engaging elements of the separable fastener are small or slender, they are rather smoothly biodegraded by microorganisms. In contrast, the base part is not very easily biodegraded because it has an appreciable thickness. If the base part is formed in a smaller thickness, it will be more easily biodegraded by microorganisms and nevertheless will be disimproved in durability and strength.

In the preferred mode of the present invention, the separable fastener has at least the base part thereof formed in a cross-sectional shape such that the specific surface area thereof may be increased. For this purpose, grooves and/or holes are formed in at least the base part or holes are extended from the reverse side of the base part through the interiors of the engaging elements, for example. The term “hole” as used in this specification should be construed as a concept which embraces both a through hole and a blind hole (or recess). In the base part having the shape of a flat plate, the formation of a coarse surface thereon is one of the effective means for increasing the specific surface area.

By increasing the specific surface area of the base part of the separable fastener as described above, the separable fastener is enabled to secure ample durability and strength and meanwhile promote the degradation of the base part by the action of microorganisms. By forming the grooves and/or the holes in the base part, the separable fastener is allowed to confer flexibility on the base part and, by virtue of ready deformation of the base part, effect quick engagement between the engaging elements and improve the engaging force as expected.

The production of the separable fastener of the present invention can be effected by any of the various methods heretofore known to the art, excepting the materials to be used therein are biodegradable resins as mentioned above. The separable fastener is not particularly limited in shape. The male fastener member of the separable fastener, for example, may be produced from a biodegradable resin by integrally molding the base part with variously shaped engaging elements, such as engaging elements shaped like hooks, engaging elements containing hemispherical head parts, and engaging elements containing conical head parts, which are raised from the base part. It may be otherwise produced by forming a base fabric manufactured by weaving or knitting biodegradable resin fibers so as to be provided with loops raised from the base fabric and cutting the loops thereby converting them into hooks. The structure of the male fastener member is not limited to a specific one. The female fastener member of the separable fastener may be produced by manufacturing biodegradable resin fibers into a pile woven and/or knitted fabric containing loops, into a woven or knitted fabric raised so as to form a multiplicity of loops on the surface thereof, or into non-woven fabric. Any type of the female fastener may be used so long as it is invariably capable of allowing the engaging elements of the male fastener member to be engaged therewith. Further, by shaping the head parts of the engaging elements so as to project hook parts in opposite sides or in numerous directions, the separable fastener enables the hook parts to engage mutually and functions concurrently as a male member and a female member.

Now, the various modes of the biodegradable separable fastener of the present invention will be described specifically below with reference to the embodiments illustrated in the accompanying drawings.

FIG. 10 and FIG. 11 illustrate the separable fastener made of a biodegradable resin as the first embodiment of the present invention; FIG. 10 representing a perspective view of a male fastener member 30 and FIG. 11 representing the state of engagement between the male fastener member 30 and a female fastener member 40.

The male fastener member 30 is manufactured by integrally molding a base part 31 and a multiplicity of hook-like engaging elements 32 projected from the base part with such a biodegradable resin as mentioned above. The engaging elements 32 are formed astride the reinforcing ribs 33 which are arranged at a prescribed interval in the longitudinal direction of the base part. On the reverse side of the base part 31, the grooves 34 are formed as extended in the longitudinal direction so as to facilitate the degradation of the fastener member by the action of microorganisms and also to ensure retention of proper flexibility and strength. The grooves 34 give rise to longitudinal rib 35 therebetween.

This male fastener member 30 and the female fastener member 40 which have a multiplicity of looped engaging elements 42 projected from the obverse side of a base part 41 manufactured by weaving or knitting biodegradable resin fibers are brought into fast engagement by the fact that the hooked engaging element 32 are caught on the looped engaging elements 42 as shown in FIG. 11.

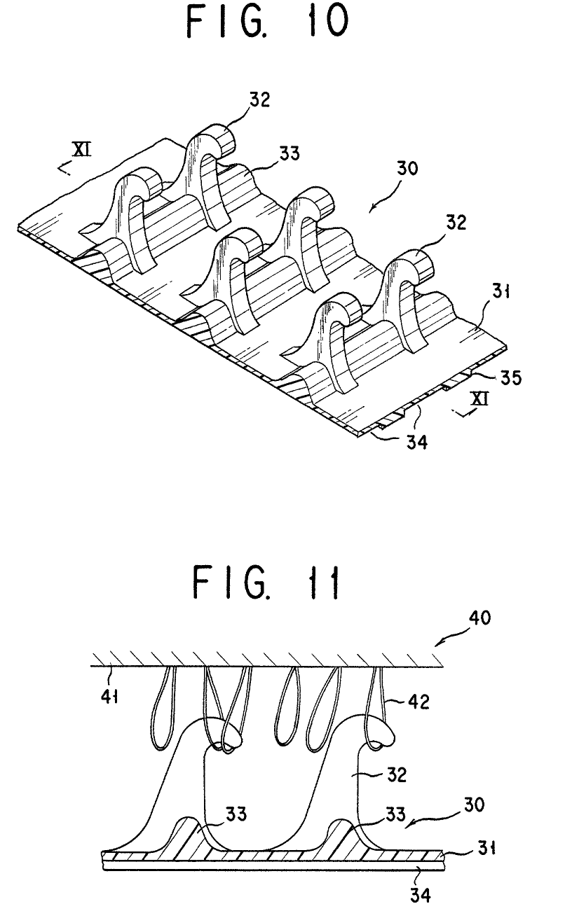

FIG. 12 and FIG. 13 illustrate the second embodiment of the separable fastener made of the biodegradable resin according to the present invention; FIG. 12 representing a perspective view of the male fastener member 30a and FIG. 13 depicting the state of engagement between the male fastener member 30a and the female fastener member 40.

The male fastener member 30a of the present embodiment differs from that of the first embodiment mentioned above in respect that the engaging elements 32a each formed of a pair of adjacent hook pieces 36 and 37 having the hooked leading ends thereof pointed in the mutually opposite directions are raised on the base part 31a, that the reinforcing ribs 33a are intermittently formed exclusively in the base parts of the relevant engaging members 32a, and that the grooves 34a are formed in the lateral direction on the reverse side of the base part 31a for the purpose of ensuring the formation of a bend in the lateral direction.

The female fastener member 40 has the same structure as that of the first embodiment mentioned above.

The male fastener members of biodegradable resin mentioned above may be manufactured with a molding apparatus as disclosed in U.S. Pat. No. 3,312,583 or published Japanese Patent Application, KOKAI (Early Publication) No. 6-38811, for example, and subjected to a suitable modification such as, for example, the formation of groove-forming ribs in a die or the additional use of a groove-forming roll.

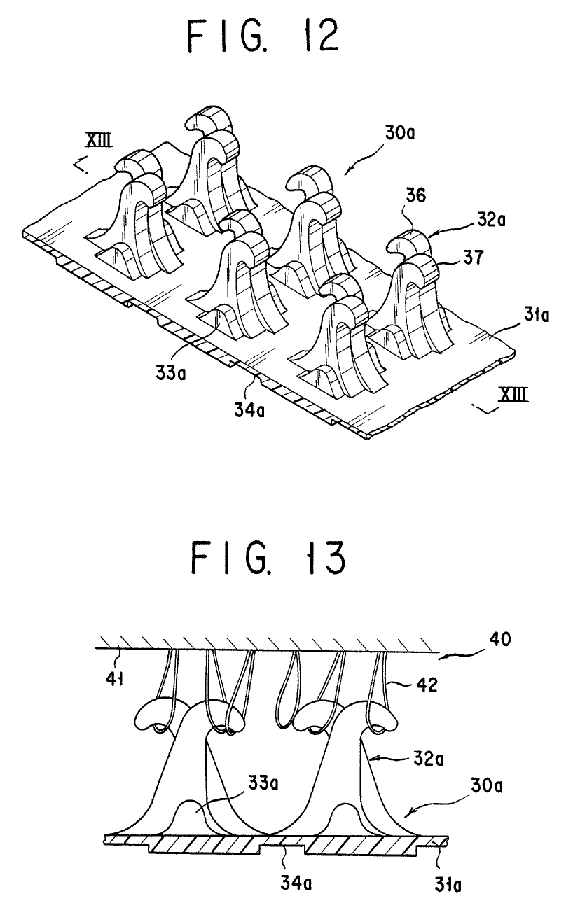

FIG. 14 and FIG. 15 illustrate the third embodiment of the separable fastener made of the biodegradable resin according to the present invention, i.e. a ribbon-like separable fastener 30b which is composed of identical male or female fastener member.

Though the separable fastener 30b is identical with those of the embodiments mentioned above in respect that the base part 31b and the multiplicity of engaging elements 32b are integrally molded with a biodegradable resin, it is different therefrom in respect that the engaging elements 32b are each provided with a head part formed of a pair of hook pieces 36b and 37b projected in an arced shape toward the opposite sides, that a multiplicity of grooves 34b are formed in the longitudinal direction on the upper side of the base part 31b at the positions seating the engaging elements 32b, and that holes 38b are formed in the grooves 34b on the opposite sides of the engaging elements 32b. The formation of the grooves 34b and the holes 38b in the base part 31b of the separable fastener 30b can facilitate the biodegradation by microorganisms and, at the same time, impart proper flexibility and strength to the separable fastener. Since this separable fastener 30b is provided with a multiplicity of engaging elements 32b each composed of a pair of hook pieces 36b and 37b projecting toward the opposite sides, the hook pieces of one fastener member can engage the hook pieces of the other fastener member when these two fastener members are laid one over the other in such a manner that the engaging elements thereof may confront each other.

The separable fastener 30b of the present embodiment can be molded by injecting the biodegradable resin into a cavity to be defined by an upper and a lower die having a cavity of a prescribed shape. The separable fastener 30b of the present embodiment, unlike those of the embodiments described above, is molded in the shape of a ribbon (one-piece product) of a prescribed area. Where a wide area stands in need of a fastening, therefore, a multiplicity of such separable fasteners 30b are used as arrayed adjacently.

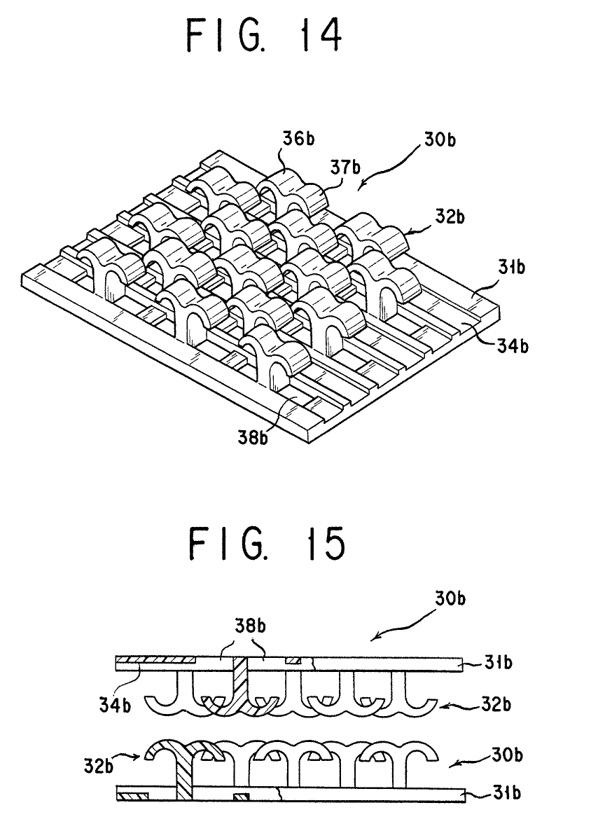

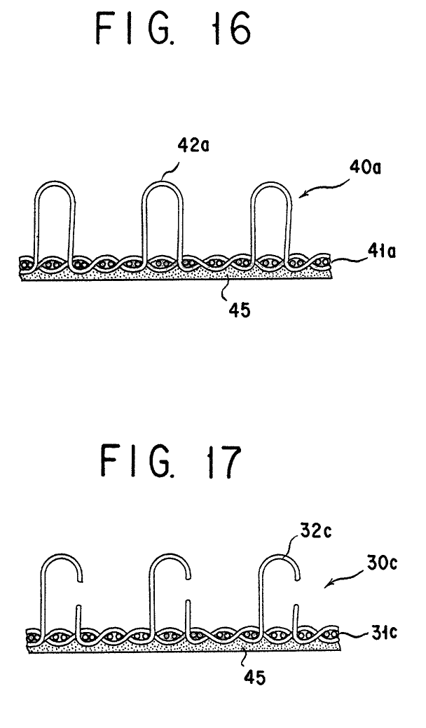

FIG. 16 and FIG. 17 illustrate the fourth embodiment of the separable fastener made of the biodegradable resin according to the present invention, i.e. a separable fastener which is manufactured by preparing monofilaments or multifilements of the biodegradable resin and interweaving them.

In a female fastener member 40a shown in FIG. 16, pile yarns formed of biodegradable resin filaments are interwoven in a pile pattern into a base part (base fabric) 41a produced by plain weaving biodegradable resin filaments so as to give rise to looped female engaging elements 42a which protrude from the obverse side of the base part 41a. A male fastener member 30c shown in FIG. 17 is identical in structure with the female fastener member 40a mentioned above except that the loops are partially cut to form hooked engaging elements 32c. Incidentally, the separable fastener shown in FIG. 17 may be used as the identical male or female fastener member.

A back coat 45 formed of either a water-soluble resin or a biodegradable resin and adapted to prevent the woven yarns from being frayed is applied to the reverse side of the female fastener member 40a and the male fastener member 30c. When the back coat 45 is manufactured with a water-soluble resin, it is allowed, on being moistened with water, to function as an adhesive layer. When the separable fasteners 30c and 40a constructed as described above are discarded, they have no possibility of posing the problem of pollution with waste because the parts (31c, 32c, 41a, and 42a) made of the biodegradable resin are disintegrated by the action of microorganisms and the back coat 45 made of the water-soluble resin is completely dissolved as by rainwater. Further, when the back coat 45 of the water-soluble resin is completely dissolved, the base parts 31c and 41a are turned into naked woven textures of biodegradable resin filaments abounding in voids and quickly undergo biodegradation produced by the microorganisms.

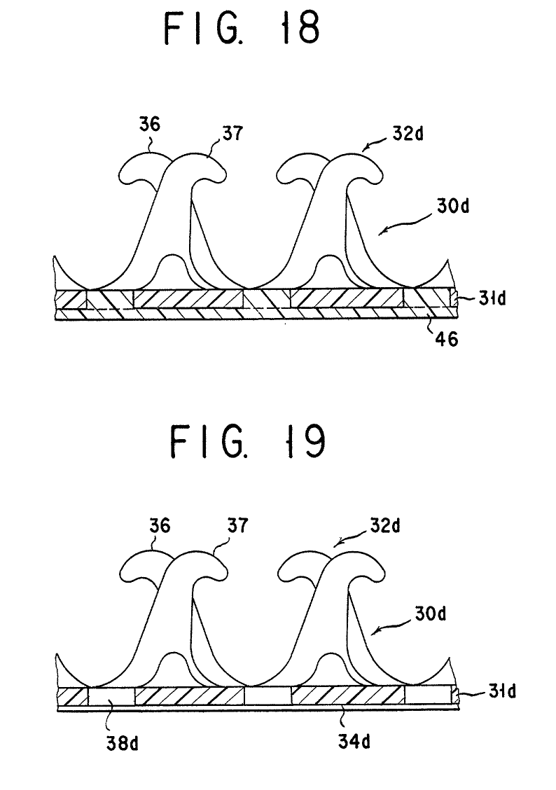

FIG. 18 and FIG. 19 illustrate the fifth embodiment of the separable fastener made of the biodegradable resin according to the present invention, i.e. one example of the method for the formation of holes and grooves in the base part of the separable fastener owing to the dissolution of the water-soluble resin in a solvent. Engaging elements 32d of a male fastener member 30d are identical in shape with those of the embodiment illustrated in FIG. 12.

In this case, by molding the engaging elements 32d and part of a base part 31d of the male fastener member 30d with the biodegradable resin and the parts of the base part intended to form the holes and the grooves with the water-soluble resin 46 and then immersing the molded product in a solvent such as water or an aqueous alcohol solution thereby inducing dissolution of the water-soluble resin 46, the male fastener member 30d which has holes 38d and grooves 34d formed in the base part 31d as illustrated in FIG. 19 will be obtained.

The male fastener member 30d which has the water-soluble resin 46 superposed on the rear side of the base part 31d as illustrated in FIG. 18 may be used in its unmodified state. In this case, the water-soluble resin 46, when moistened with water, functions as an adhesive layer. When the male fastener member 30d which is constructed as described above is discarded, the biodegradation by microorganisms proceeds quickly thereon because the water-soluble resin 46 is completely dissolved as by rainwater and, as a result, the holes 38d and the grooves 34d are caused to emerge in the male fastener member 30d made of the biodegradable resin.

The male fastener member 30d which is constructed as illustrated in FIG. 18 can be formed by preparing a water-soluble resin film having formed in advance thereon such protruding parts or ridges as conform with the holes and the grooves and pressing the water-soluble resin film fast against the rear side of the male fastener member which is formed of the biodegradable resin and is still in a partly molten state.

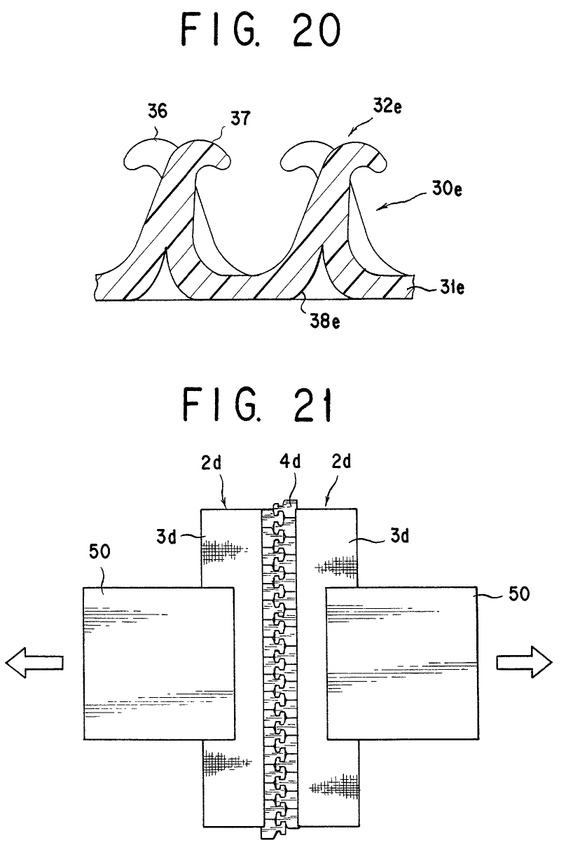

FIG. 20 illustrates the sixth embodiment of the male fastener member made of the biodegradable resin according to the present invention. A male fastener member 30e of the present embodiment is provided with holes 38e extending from a base part 31e through engaging elements 32e and consequently enabled to acquire still higher flexibility and accelerate the biodegradation by microorganisms. The formation of these holes 38e can be carried out, for example, by preparing the water-soluble resin film having formed thereon acute protruding parts conforming in shape with the holes 38e mentioned above, pressing the water-soluble resin film into fast adhesion with the male fastener member 30e freshly molded and still remaining in the partly molten state or softened state in such a manner that the protruding parts may be buried therein, then allowing the male fastener member to cool and solidify, and thereafter causing the water-soluble resin film to dissolve out into a proper solvent.

As another example of the method for forming such holes and/or grooves as mentioned above, the method which comprises preparing the water-soluble resin film having formed thereon such protruding parts and/or ridges as correspond to the holes and/or the grooves, disposing the water-soluble resin film in a cavity of a lower die, and molding the fastener member with the biodegradable resin by utilizing the water-soluble resin film as the cavity face of the lower die may be adopted.

As the water-soluble resin to be used for the formation of the grooves and/or the holes in the separable fastener or as an adhesive layer, any resin may be used effectively so long as it possesses a hydrophilic group such as hydroxyl group, carboxylic group, or sulfonic acid group, exhibits solubility in water, and manifests moldability. As concrete examples of the material, polyvinyl alcohol, modified polyvinyl alcohol, polyacrylic acid, polyethylene oxide, CMC (carboxymethyl-cellulose), and gum may be cited. Among other materials enumerated above, the modified polyvinyl alcohol (such as, for example, the graft of a polyoxyalkylene to a vinyl alcohol-allyl alcohol copolymer produced by Nippon Synthetic Chemical Industry Co., Ltd. and marketed under trademark designation of “Ecomaty AX”) can be used particularly advantageously.

As the other biodegradable resin which may be optionally used in combination with the biodegradable resin of the present invention, any biodegradable resin may be used so long as it manifests moldability and proper flexibility and hardness and possesses an ability to yield to degradation by the action of microorganisms. As concrete examples of the resin, microbial fermentative production type resins such as a copolymer of hydroxybutyric acid with hydroxyvaleric acid (produced by Zeneka K.K. and marketed under trademark designation of “Biopol”), natural macromolecular (starch) type resins such as a blend of starch with modified polyvinyl alcohol (produced by Nippon Synthetic Chemical Industry Co., Ltd. and marketed under trademark designation of “Mater-Bi”), and a blend of starch with a biodegradable synthetic polymer (produced by Werner Lambert Corp. of U.S. and marketed under trademark designation of “Novon”) and chemical synthetic resins such as polycaprolactone (produced by Daicel Chemical Industry K.K. and marketed under trademark designation of “Praccel”) may be cited.

Now, the present invention will be described below with reference to working examples which have specifically demonstrated the effect of the present invention.

### EXAMPLE 1

Commercially available biodegradable resins were used as the raw materials herein. In the present example, the aliphatic polyester type biodegradable resin made by Showa Highpolymer Co., Ltd. and sold under the trademark designation of “Bionolle” #1020 was used as polybutylene succinate and the polylactic acid type biodegradable resin made by Shimadzu Seisakusho K.K. and sold under the trademark designation of “LACT” was used as polylactic acid. First, these products in the form of pellets were dried under a reduced pressure at 80° C. for four hours. The two resins weighed out in amounts calculated to result in a Bionolle/LACT weight ratio of 75/25 were thrown into a kneading device. They were kneaded under the kneading conditions of 170° C. of kneading temperature, 60 r/min of mixer revolution number, and 5 minutes of kneading time to obtain the resin a of the quality shown in Table 1. Likewise, the resin b was obtained under the kneading conditions of 190° C. of kneading temperature, 60 r/min of mixer revolution number, and 5 minutes of kneading time and the resin c was obtained under the kneading conditions of 210° C. of kneading temperature, 60 r/min of mixer revolution number, and 5 minutes of kneading time.

The resins a-c prepared by the procedure described above were severally extruded in the form of a monofilament and tested for tensile strength by the use of a tensile tester. The cross section of the monofilament of the resin a, b, or c was observed to measure the diameters of the particles of LACT as the polylactic acid component. The data of tensile strength and the data of diameter of LACT particles consequently obtained are shown collectively in Table 1. It is clearly noted from the results shown in Table 1 that the LACT particles in each of the resins had diameters of not more than 9 μm and the strength of the kneaded resin increased in accordance as the particle diameter decreased.

The resins a, b, and c were severally processed with an injection molding device to obtain injection molded slide fasteners A, B, and C of the 5VS specification and these fasteners were tested for lateral tensile strength. The results of the test are shown in conjunction with the diameters of LACT particles in Table 1.

The lateral tensile strength was measured as illustrated in FIG. 21. With fastener stringers 2d so held as to keep coupling elements 4d in a meshed state, fastener tapes 3d were drawn by the use of a tensile tester at a fixed rate (300 mm/min.) in the direction of engagement of the stringers as illustrated in FIG. 21 to test for tensile resistance. Cramps 50 used in the test had a width of 25 mm.

TABLE 1

| | Kneading | | Diameter | | Lateral |
|---|---|---|---|---|---|
| | tempera- | Tensile | of LACT | | tensile |
| | ture | strength | particles | Molded | strength |
| Resin | (° C.) | (MPa) | (μm) | article | (kgf/25 mm) |
| a | 170 | 41 | 7.3 | A | 30 |
| b | 190 | 40 | 5.5 | B | 32 |
| c | 210 | 48 | 4.1 | C | 32 |

It is clearly noted from the results shown in Table 1 that the lateral tensile strength of the fastener increased in proportion as the diameter of the LACT particles decreased. All the molded articles showed such magnitudes of lateral tensile strength as exceeded the standard level of 25 kgf/25 mm of 5VS specified in JIS (Japanese Industrial Standard). The results demonstrate the effect brought about in the improvement of strength by the fact that the diameter of LACT particles was not more than 9 μm.

### EXAMPLE 2

Commercially available biodegradable resins were used as the raw materials herein. In this example, the talc-containing (30%) grade of the aliphatic polyester type biodegradable resin made by Showa Highpolymer Co., Ltd. and sold under the trademark designation of “Bionolle” #1020 was used as talc-containing polybutylene succinate and the polylactic acid type biodegradable resin made by Shimadzu Seisakusho K.K. and sold under the trademark designation of “LACT” #2010 was used as polylactic acid. First, these products in the form of pellets were dried under a reduced pressure at 80° C. for four hours. The dried resins were severally processed by the dry blend method using an injection molding device to obtain injection molded slide fasteners, namely the molded fastener A which was formed solely of the talc 30%-containing grade of Bionolle and the molded fastener B which was formed of the talc 30%-containing grade of Bionolle/LACT at a mixing ratio of 80/20 (% by weight) or Bionolle/talc/LACT at a mixing ratio of 56/24/20 (% by weight).

The resultant molded articles A and B were severally tested for lateral tensile strength. The results of the test are shown in Table 2.

TABLE 2

| Molded | Material composition | Lateral tensile |
|---|---|---|
| article | (% by weight) | strength (kgf/25 mm) |
| A | Bionolle/talc = 70/30 | 29.7 |
| B | Bionolle/talc/LACT = 56/24/20 | 35.9 |

When the sample solely using the talc-containing Bionolle (molded article A) and the sample using the talc-containing Bionolle for the continuous phase and the LACT for the disperse phase (molded article B) as indicated in Table 2 are compared, it is found that the fastener of the molded article B using the LACT for the disperse phase showed greater lateral tensile strength. The test results demonstrate the effect which was brought about in the increase of strength by the construction of a three-phase structure formed of the continuous phase of the inorganic filler-containing biodegradable resin and the disperse phase of the biodegradable resin.

The formed article of biodegradable resin according to the present invention has no possibility of bringing destruction on the earth's environment or inducing public nuisance when it is discarded after use because it is composed of a biodegradable resin which is decomposed by microorganisms in soil or in water when it is discarded after use and an optionally incorporated inorganic filler which is made of an inorganic compound occurring in the physical world. Further, since the products made of biodegradable resins are reduced in the form of compost to the earth, they have no possibility of turning into scattered debris like those of ordinary plastic products and doing harm to wild animals. The fact that these products lose volume in consequence of the degradation results in elongating the life of a landfill or stabilizing the condition of the landfill. Further, when these products are disposed of by incineration, since the biodegradable resin emits a small amount of heat during the incineration, the possibility of the combustion thereof doing harm to the incinerator is reduced. The biodegradable separable fastener which embodies the present invention can be advantageously utilized as connecting pieces for various disposable products such as tying bands, covers for seedling, covers for nursing mushrooms, and diapers which are manufactured from a biodegradable resin or a water-soluble resin.

While certain specific embodiments and working examples have been disclosed herein, the invention may be embodied in other specific forms without departing from the spirit or essential characteristics thereof. The described embodiments and examples are therefore to be considered in all respects as illustrative and not restrictive, the scope of the invention being indicated by the appended claims rather than by the foregoing description and all changes which come within the meaning and range of equivalency of the claims are, therefore, intended to be embraced therein.

What is claimed is:

1. A formed article made of a biodegradable resin material comprising a continuous phase of at least one aliphatic polyester selected from the group consisting of polybutylene succinate and polyethylene adipate and a disperse phase of polylactic acid, wherein said aliphatic polyester component accounts for a proportion of not less than 50% by weight of the material and said polylactic acid are dispersed in the form of particles in said aliphatic polyester.

2. The formed article according to claim 1, wherein said aliphatic polyester component accounts for a proportion in the range of 55 to 90% by weight of the material.

3. The formed article according to claim 1, wherein said continuous phase is formed of an inorganic filler-containing aliphatic polyester.

4. The formed article according to claim 3, wherein said disperse phase accounts for a proportion in the range of 5 to 45% by weight of the material.

5. The formed article according to claim 3, wherein said inorganic filler is at least one member selected from the group consisting of talc, calcium carbonate, clay, kaolin, carbon, mica, silica, aluminum oxide, aluminum hydroxide, magnesium carbonate, magnesium oxide, magnesium hydroxide, and barium sulfate.

6. The formed article according to claim 3, wherein said inorganic filler contained in said continuous phase is talc.

7. The formed article according to claim 3, wherein said inorganic filler contained in said continuous phase is calcium carbonate.

8. The formed article according to claim 3, wherein said inorganic filler is present in said continuous phase in an amount of 5 to 100 parts by weight, based on 100 parts by weight of said aliphatic polyester.

9. The formed article according to claim 1, wherein the diameter of the particles of said polylactic acid is not more than 9 μm.

10. The formed article according to claim 1, wherein said formed article is a slide fastener.

11. The formed article according to claim 1, wherein said formed article is a separable fastener.
